(19) United States
(12) Patent Application Publication
(10) Pub. No.: US 2023/0187867 A1
(43) Pub. Date: Jun. 15, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Tetsuya MIYAMURA, Mie (JP); Yutaka KOBAYASHI, Mie (JP); Teruo HARA, Mie (JP)

(21) Appl. No.: 17/926,468

(22) PCT Filed: May 17, 2021
(86) PCT No.: PCT/JP2021/018604

§ 371 Date: Nov. 18, 2022

(30) Foreign Application Priority Data
Jun. 5, 2020 (JP) 2020-098290

(51) Int. Cl. H01R 13/187; H01R 13/11; H01R 13/193

(52) U.S. Cl. CPC H01R 13/187; H01R 13/111; H01R 13/193

(57) ABSTRACT

A connector is provided with first and second housings connectable to each other, a slider to be supported on the first housing, and a biasing member to be arranged between the slider and the first housing. The second housing includes a stopper portion for stopping a connecting operation of the first and second housings by coming into contact with a contact portion of the first housing and a slider lock receiving portion to be locked by a slider lock portion of a slider. The biasing member has a biasing force for pushing the first housing toward a connection position to the second housing when the slider lock receiving portion is locked by the slider lock portion and contact between the stopper portion and the contact portion is released.

### TECHNICAL FIELD

The present disclosure relates to a connector.

### BACKGROUND

A connector disclosed in Patent Document 1 is provided with a female housing and a male housing connectable to each other, a slide member movably supported on the male housing and a coil spring arranged between the slide member and the male housing. The female housing includes a lock arm for holding the both housings (female housing and male housing) in a connected state. The front end of the coil spring is in contact with the slide member and the rear end of the coil spring is in contact with the male housing.

If the both housings are incompletely connected, the lock arm is resiliently deformed and comes into contact with the slide member. The slide member moves back by being pushed by the female housing. If the slide member moves back, the coil spring is contracted between the slide member and the male housing. If a connecting operation of the both housings is stopped in this stage, the female housing is pushed back by a biasing force of the coil spring. Thus, the both housings are separated without being left incompletely connected. If the both housings are properly connected, the lock arm resiliently returns to be separated from the slide member. The slide member is moved forward by the biasing force of the coil spring.

### PRIOR ART DOCUMENT

### Patent Document

Patent Document 1: JP 2018-195423 A

### SUMMARY OF THE INVENTION

### Problems to be Solved

When the both housings are in the incompletely connected state, a male terminal accommodated in the male terminal starts to be inserted into a female terminal accommodated in the female housing. Here, if a worker stops the connecting operation of the both housings and the both housings are separated, the connecting operation of the both housings has to be performed again. As a result, the number of sliding movements of contact points of the both terminals (female terminal and male terminal) increases more than necessary and contact wear may occur between the both terminals.

Accordingly, the present disclosure aims to provide a connector provided with a function of guaranteeing connection having high connection reliability.

### Means to Solve the Problem

The present disclosure is directed to a connector with a first housing, a second housing connectable to the first housing, a slider to be supported on the first housing, the slider being relatively movable with respect to the first and second housings, and a biasing member to be resiliently deformably arranged between the slider and the first housing, the first housing including a contact portion, the slider including a slider lock portion, the second housing including a stopper portion for stopping a connecting operation of the first and second housings by coming into contact with the contact portion while the slider is being pushed toward the second housing and a slider lock receiving portion for stopping push-in of the slider by being locked by the slider lock portion, and the biasing member having a biasing force for pushing the first housing toward a connection position to the second housing when the slider lock receiving portion is locked by the slider lock portion and contact between the stopper portion and the contact portion is released.

### Effect of the Invention

According to the present disclosure, it is possible to provide a connector provided with a function of guaranteeing connection having high connection reliability.

### BRIEF DESCRIPTION OF THE DRAWINGS

FIG. 1 is an exploded perspective view of a first connector viewed from front in an embodiment.

FIG. 2 is a perspective view of the first connector viewed from front.

FIG. 3 is a perspective view of a second connector viewed from behind.

FIG. 4 is a perspective view of a slider viewed from front.

FIG. 5 is a perspective view showing the halved first and second connectors having a connecting operation thereof stopped.

FIG. 6 is a side view in section of the first and second connectors having the connecting operation thereof stopped.

FIG. 7 is a section along A-A of FIG. 6.

FIG. 8 is a section, corresponding to FIG. 7, of the first and second connectors immediately before a connection position is reached.

FIG. 9 is a side view in section of the first and second connectors at the connection position.

FIG. 10 is a section along B-B of FIG. 9.

FIG. 11 is a plan view of the first and second connectors at the connection position.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing, a second housing connectable to the first housing, a slider to be supported on the first housing, the slider being relatively movable with respect to the first and second housings, and a biasing member to be resiliently deformably arranged between the slider and the first housing, the first housing including a contact portion, the slider including a slider lock portion, the second housing including a stopper portion for stopping a connecting operation of the first and second housings by coming into contact with the contact portion while the slider is being pushed toward the second housing and a slider lock receiving portion for stopping push-in of the slider by being locked by the slider lock portion, and the biasing member having a biasing force for pushing the first housing toward a connection position to the second housing when the slider lock receiving portion is locked by the slider lock portion and contact between the stopper portion and the contact portion is released.

According to the above configuration, since the stopper portion comes into contact with the contact portion and the connecting operation of the first and second housing is stopped while the slider is being pushed toward the second housing, it is possible to prevent the start of a connecting operation of the both terminals accommodated in the first and second housings. As a result, the occurrence of unnecessary contact wear between the both terminals can be prevented and connection reliability can be enhanced.

When the slider lock receiving portion is locked by the slider lock portion and the contact between the stopper portion and the contact portion is released, the first housing can reach the connection position to the second housing by being pushed by the biasing force of the biasing member.

On the other hand, if the push-in of the slider is stopped before the slider lock receiving portion is locked by the slider lock portion, the slider is pushed back in a direction separating from the second housing by the biasing force of the biasing member. As a result, it is possible to prevent a situation where the first and second housings are left in an incompletely connected state before reaching the connection position. Note that the “connection position” means the positions of the first and second housings when the both terminals accommodated in the first and second housings are properly connected.

(2) Preferably, the slider includes a restricting portion for keeping the contact between the stopper portion and the contact portion by pressing the stopper portion. According to this configuration, the contact between the stopper portion and the contact portion can be reliably maintained while the slider is being pushed toward the second housing. By the separation of the restricting portion from the stopper portion, the pressing of the stopper portion can be automatically released.

(3) The slider may include a frame-like frame portion behind a surface on a rear side of the first housing when a moving side of the first housing toward the connection position to the second housing is a front side and a side opposite to the front side is the rear side. According to this configuration, the first and second housings can reach a connected state by pushing the frame portion. Here, since the frame portion is frame-like, a wide push-in region (gripping region) can be secured. Further, a wire and the like can be inserted inside the frame portion.

### Details of Embodiment of Present Disclosure

[Embodiment]

A specific example of a connector according to an embodiment of the present disclosure is described below with reference to the drawings. Note that the present invention is not limited to this illustration and is intended to be represented by claims and include all changes in the scope of claims and in the meaning and scope of equivalents.

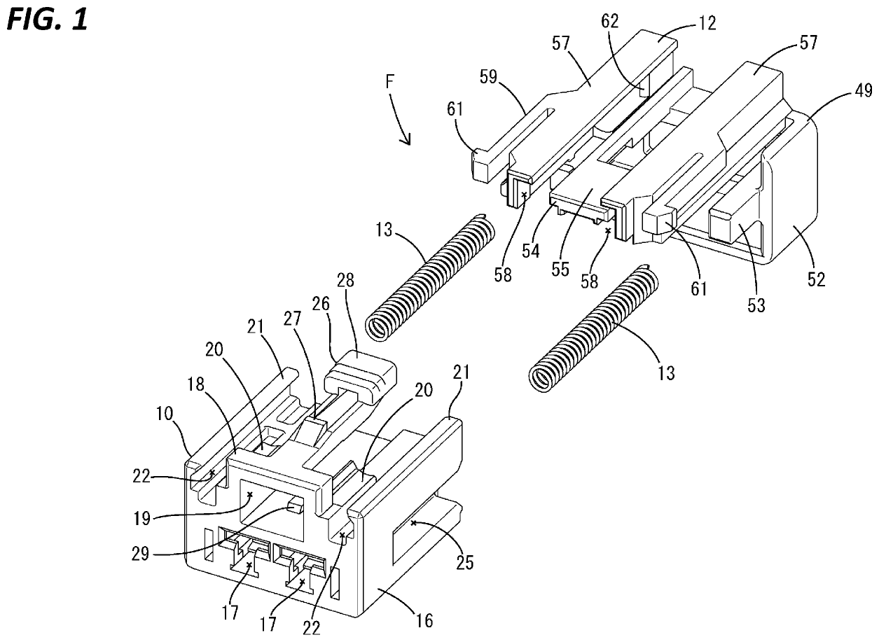

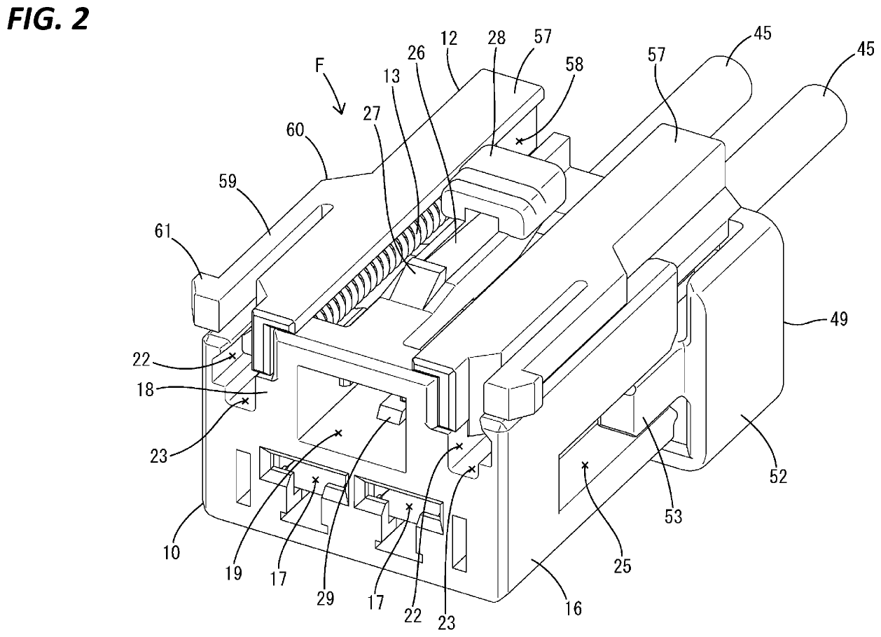

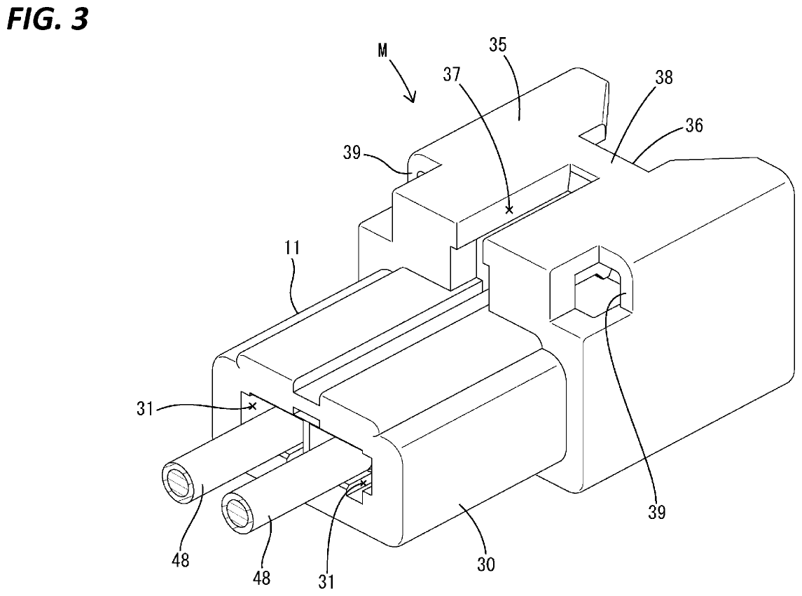

The connector is provided with a first housing 10, a second housing 11 connectable to the first housing 10, a slider 12 to be supported on the first housing 10 and biasing members 13 to be arranged between the slider 12 and the first housing 10. Further, the connector is provided with a plurality of first terminal fittings 14 to be accommodated into the first housing 10 and a plurality of second terminal fittings 15 to be accommodated into the second housing 11. The first housing 10, the first terminal fittings 14, the slider 12 and the biasing members 13 constitute a female first connector F (see FIG. 2). The second housing 11 and the second terminal fittings 15 constitute a male second connector M (see FIG. 3). Note that, in the following description, surface sides of the first and second connectors F, M facing each other when a connecting operation of the first and second housings 10, 11 is started are referred to as front sides concerning a front-rear direction. A vertical direction is based on a vertical direction of FIGS. 1 to 6 and 9.

<First Housing>

The first housing 10 is made of synthetic resin and includes, as shown in FIGS. 1 and 2, a housing body 16 in the form of a rectangular block. The housing body 16 includes a plurality of first cavities 17. The respective first cavities 17 are laterally arranged in a pair in the housing body 16. Each first cavity 17 extends in the front-rear direction and is open in the front and rear surfaces of the housing body 16. The first terminal fitting 14 is inserted and retained in the first cavity 17.

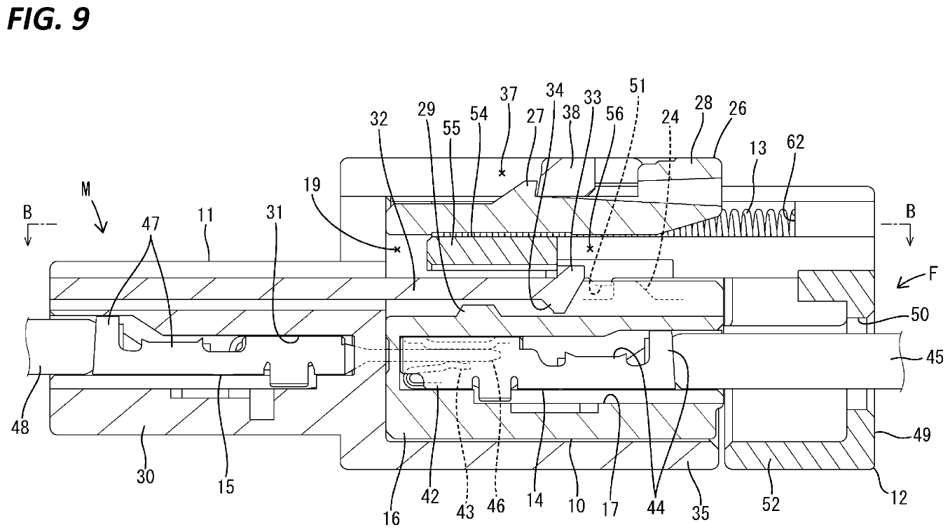

A base wall portion 18 is provided to project in a laterally central part of a front end part of the upper surface of the housing body 16. The base wall portion 18 is in the form of a frame rectangular in a front view, and includes a through hole 19 having a rectangular cross-section inside. Rib-like inner wall portions 20 extending rearward from both left and right end parts of the base wall portion 18 are provided to project on the upper surface of the housing body 16. Plate-like outer wall portions 21 are provided to project on both left and right end parts of the upper surface of the housing body 16. Guide spaces 22 are formed between the inner wall portions 20 and the outer wall portions 21. As shown in FIG. 2, the slider 12 is inserted into the guide spaces 22 and movable in the front-rear direction with respect to the first housing 10. Groove portions 23 extending in the front-rear direction are provided in the both left and right end parts of the upper surface of the housing body 16. A retaining receiving portion 24 (see FIG. 9) shaped to close the inside of the groove portion 23 is provided in the groove portion 23. Guide grooves 25 are provided in both left and right side surfaces of the housing body 16. The guide grooves 25 extend in the front-rear direction and are open in the rear surface of the housing body 16.

The first housing 10 includes a first lock portion 26 extending rearward from a laterally central part of the base wall portion 18. The first lock portion 26 is in the form of a strip plate long in the front-rear direction. A lock projection 27 is provided on the upper surface of the first lock portion 26. A releasing portion 28 is provided on a rear end part of the upper surface of the first lock portion 26. The upper surface of the releasing portion 28 is arranged to be higher than surrounding surfaces. The first lock portion 26 is resiliently deformable with a part connected to the base wall portion 18 as a fulcrum.

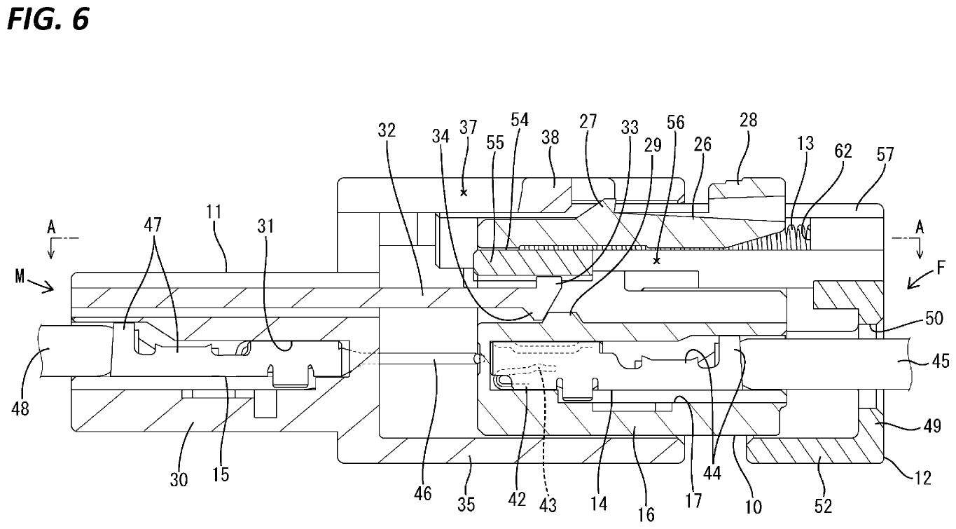

A contact portion 29 is provided to project in a laterally central part of the upper surface of the housing body 16. The contact portion 29 is arranged at a position near the base wall portion 18 in the front-rear direction. The contact portion 29 can be visually confirmed from front through the through hole 19 of the base wall portion 18. The first lock portion 26 is arranged above the contact portion 29. As shown in FIG. 6, the contact portion 29 has a trapezoidal shape, the front surface thereof is inclined rearward and the rear surface thereof is inclined forward.

<Second Housing>

The second housing 11 is made of synthetic resin and includes, as shown in FIG. 3, a terminal accommodating portion 30 in the form of a rectangular block. The terminal accommodating portion 30 includes a plurality of second cavities 31. The respective second cavities 31 are laterally arranged in a pair in the terminal accommodating portion 30 to communicate with the respective first cavities 17. Each second cavity 31 extends in the front-rear direction and is open in the front and rear surfaces of the terminal accommodating portion 30. The second terminal fitting 15 is inserted and retained in the second cavity 31.

As shown in FIG. 6, the second housing 11 includes a stopper portion 32 extending forward from a laterally central part of an upper end part of the front surface of the terminal accommodating portion 30. The stopper portion 32 is arranged in a receptacle 35 to be described later. The stopper portion 32 is in the form of a strip plate long in the front-rear direction. The stopper portion 32 is resiliently deformable with a part connected to the front surface of the terminal accommodating portion 30 as a fulcrum. A restricted portion 33 is provided to project upward in a front end part of the stopper portion 32. The upper surface of the restricted portion 33 is formed to be flat along the front-rear direction. A later-described restricting portion 54 of the slider 12 can come into contact with the upper surface of the restricted portion 33. A contacted portion 34 is provided to project downward in the front end part of the stopper portion 32. The front surface of the contacted portion 34 is inclined downward. The front surface of the contacted portion 34 can come into contact with the front surface (front surface when viewed from the first housing 10) of the contact portion 29.

The second housing 11 includes the receptacle 35 in the form of a rectangular tube projecting forward from the front end of the terminal accommodating portion 30. As shown in FIG. 3, the receptacle 35 has an external shape one size larger than the terminal accommodating portion 30. A recess 36 is provided to be open in the upper wall front end of the receptacle 35. The recess 36 is composed of a cut part rectangular in a plan view and an expanded part expanded forward from the cut part in the upper wall of the receptacle 35. The upper wall of the receptacle 35 is provided with a lock groove 37 extending in the front-rear direction and open in the rear end of the receptacle 35. The lock groove 37 is arranged above the stopper portion 32.

A second lock portion 38 is provided in the upper wall of the receptacle 35. The second lock portion 38 is shaped to extend between both left and right sides of the upper wall of the receptacle 35. The front surface of the second lock portion 38 is upright in the vertical direction and constitutes the back end of the cut part of the recess 36. As shown in FIG. 6, the rear surface of the second lock portion 38 is inclined upward and constitutes the front end of the lock groove 37.

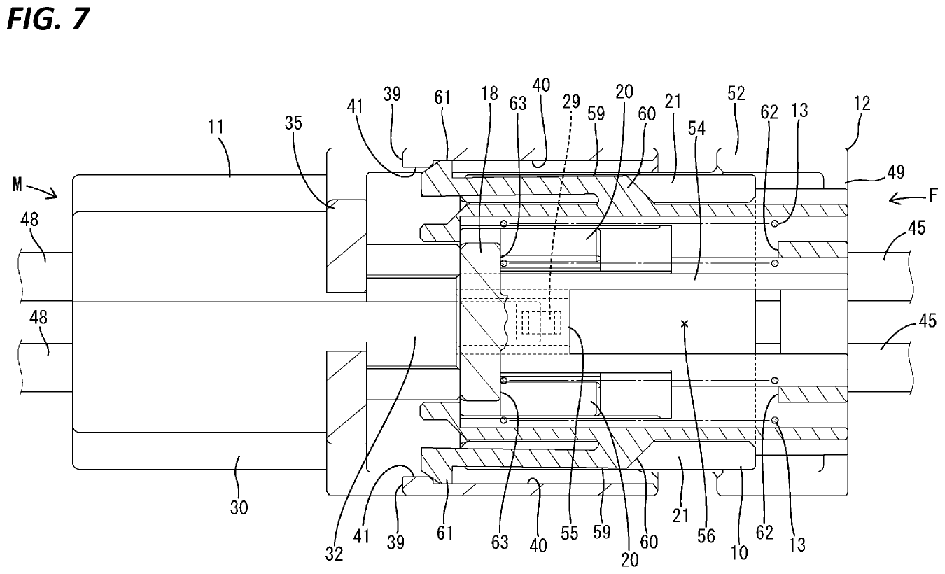

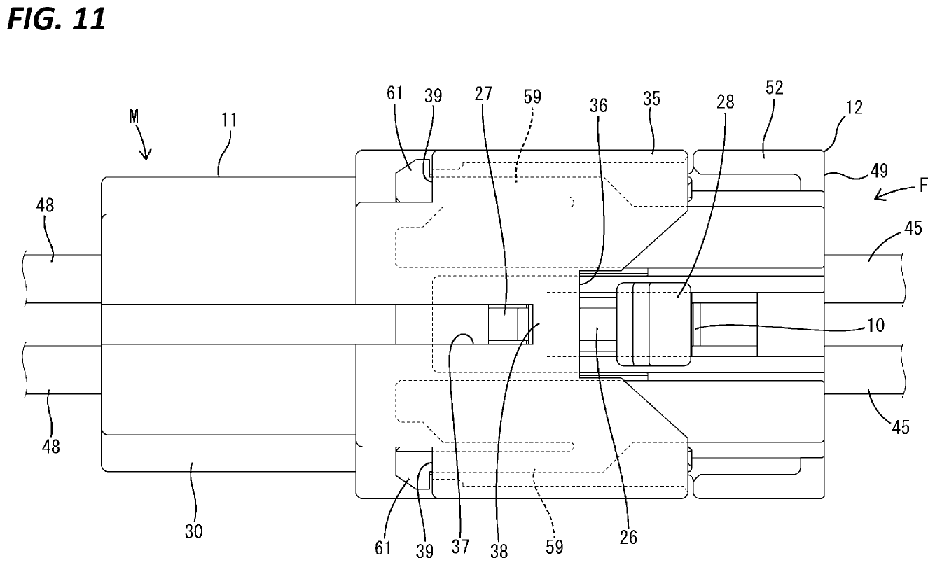

As shown in FIGS. 3 and 11, the receptacle 35 includes slider lock receiving portions 39 on both left and right end parts of an upper wall rear end. The slider lock receiving portion 39 is in the form of a hole formed by cutting a corner part of the upper wall rear end of the receptacle 35. The slider lock receiving portion 39 is open in the upper wall, rear wall and side wall of the receptacle 35. The front surface of the slider lock receiving portion 39 is arranged along directions (lateral direction and vertical direction) orthogonal to the front-rear direction in the upper and side walls of the receptacle 35. A later-described slider lock portion 59 of the slider 12 can be locked to the front surface of the slider lock receiving portion 39. As shown in FIG. 7, the receptacle 35 includes extension grooves 40 extending in the front-rear direction in upper end parts of the inner surfaces of both side walls. The front end of the extension groove 40 is open in the front end (opening end) of the receptacle 35. The rear end of the extension groove 40 is closed by a closing portion 41 provided on a front side of the slider lock receiving portion 39. The rear end of the extension groove 40 constitutes the front surface of the closing portion 41 and is inclined inward (into the receptacle 35).

<First Terminal Fitting>

The first terminal fitting 14 is a female terminal fitting and formed, such as by bending an electrically conductive metal plate. As shown in FIG. 6, a connecting body portion 42 in the form of a rectangular tube is provided in a front end part of the first terminal fitting 14. A resilient contact piece 43 is provided in the connecting body portion 42. A first barrel portion 44 in the form of an open barrel is provided in a rear end part of the first terminal fitting 14. The first barrel portion 44 is crimped and connected to an end part of a first wire 45.

<Second Terminal Fitting>

The first terminal fitting 15 is a male terminal fitting and formed, such as by bending an electrically conductive metal plate. A tab 46 extending in the front-rear direction is provided in a front end part of the second terminal fitting 15. As shown in FIG. 9, the tab 46 is inserted into the connecting body portion 42 of the first terminal fitting 14 and contacts a contact point part of the resilient contact piece 43 when the first and second housings 10, 11 are at a connection position. A second barrel portion 47 in the form of an open barrel is provided in a rear end part of the second terminal fitting 15. The second barrel portion 47 is crimped and connected to an end part of a second wire 48.

<Slider>

The slider 12 is made of synthetic resin and assembled with the first housing 10. The slider 12 is movable to a standby position where the slider 12 is arranged relatively on a rear side with respect to the first housing 10 and a push-in position where the slider 12 is arranged relatively forward of the standby position with respect to the first housing 10. As described later, the slider 12 is normally arranged at the standby position by receiving biasing forces of the biasing members 13.

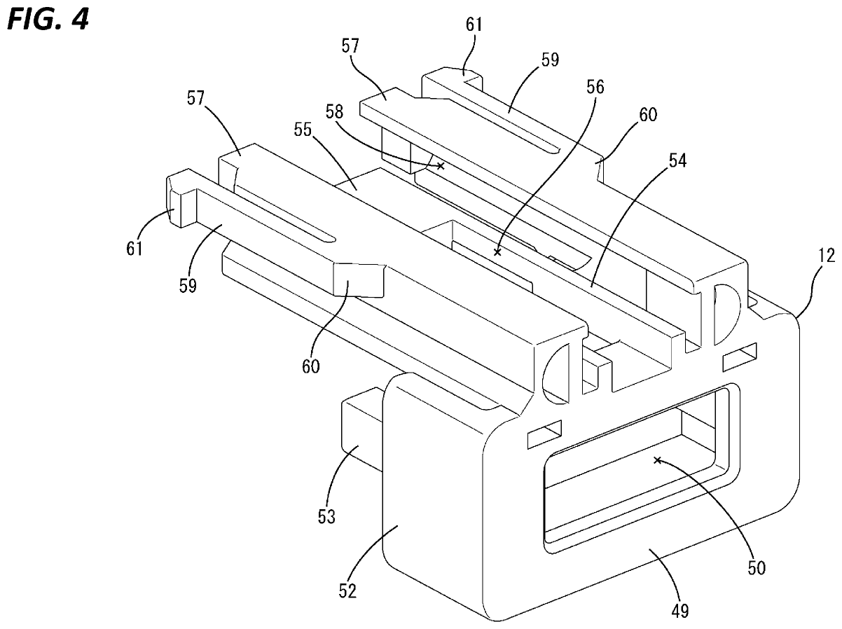

As shown in FIG. 4, the slider 12 includes a frame portion 49 in the form of a rectangular frame in a back view. The frame portion 49 is sized to cover an outer peripheral part of the rear surface of the housing body 16 over an entire periphery. The frame portion 49 is arranged behind and away from the rear surface of the housing body 16 at the standby position and arranged to be able to come into contact with the rear surface of the housing body 16 at the push-in position. An opening 50 having a rectangular cross-section is formed inside the frame portion 49. As shown in FIG. 6, the first wires 45 pulled out from the first cavities 17 are inserted through the opening 50 of the frame portion 49. The frame portion 49 includes a peripheral wall portion 52 protruding forward in a lower side part and left and right side parts of a rectangular frame shape. By gripping and pushing the frame portion 49 forward, the slider 12 is moved from the standby position to the push-in position. The peripheral wall portion 52 is arranged to cover a rear end part of the lower surface and rear end parts of both left and right side surfaces of the housing body 16 at the push-in position.

Guide portions 53 are provided to project forward on the left and right side parts of the frame portion 49. The guide portion 53 is in the form of a rectangular column and arranged inside the peripheral wall portion 52. The front end of the guide portion 53 is arranged forward of the front end of the peripheral wall portion 52. As shown in FIG. 2, the guide portion 53 is inserted into the guide groove 25 of the first housing 10. The guide portions 53 slide on the inner surfaces of the guide grooves 25, whereby a movement of the slider 12 with respect to the first housing 10 is guided.

The restricting portion 54 is provided to project forward in a laterally central part of the upper side part of the frame portion 49. As shown in FIG. 7, the restricting portion 54 includes a pair of arm parts extending in the front-rear direction and a restricting body 55 linking the both arm parts in a front end part. The restricting portion 54 is provided with an escaping portion 56 in the form of a rectangular hole long in the front-rear direction in a plan view. When the slider 12 is at the standby position, the restricting body 55 of the restricting portion 54 is arranged behind the base wall portion 18 to face the contact portion 29 from above. When the slider 12 is at the push-in position, the restricting body 55 of the restricting portion 54 is arranged through the through hole 19 of the base wall portion 18.

As shown in FIG. 4, rail portions 57 are provided to project forward on both left and right end parts of the upper side part of the frame portion 49. A pair of the rail portions 57 are arranged on both sides of the restricting portion 54. The rail portions 57 can be inserted into the guide spaces 22 of the first housing 10 and slide on the inner wall portions 20 and the outer wall portions 21 in the process of moving the slider 12. The rail portions 57 include body parts having an L-shaped cross-section and arranged along left and right corner parts of the base wall portion 18.

An accommodation space 58 is provided inside the body portion of the rail portion 57. The accommodation space 58 is open in the inner surface of the rail portion 57 and closed at a rear end part. The biasing member 13 is accommodated into the accommodation space 58 of the rail portion 57. A retaining portion 51 (see FIG. 9) lockable to the retaining receiving portion 24 is provided on the lower surface of the rail portion 57.

The slider lock portion 59 is provided outside the rail portion 57. A pair of the slider lock portions 59 are arranged to correspond to the left and right rail portions 57. The slider lock portion 59 includes a base end portion 60 projecting outward from an intermediate part in the front-rear direction of the outer surface of the rail portion 57, an extending part extending forward from the base end portion 60 in parallel to the rail portion 57 and a lock body portion 61 projecting outward from the front end of the extending part. When the slider 12 is at the standby position, the lock body portions 61 of the slider lock portions 59 are inserted into the extension grooves 40 of the receptacle 35. When the slider 12 is at the push-in position, the lock body portions 61 of the slider lock portions 59 are fit and locked into the slider lock receiving portions 39. When the first and second housings 10, 11 are at the connection position, the lock body portions 61 are arranged to be exposed on an outer surface side of the receptacle 35 as shown in FIG. 11.

<Biasing Members>

As shown in FIG. 1, the biasing member 13 is configured as a coil spring (compression coil spring) made of metal. The biasing member 13 is arranged along the front-rear direction in the accommodation space 58 of the rail portion 57. A pair of the biasing members 13 are arranged to correspond to the left and right rail portions 57. As shown in FIG. 7, the rear ends of the biasing members 13 are supported on rear end parts (hereinafter, referred to as slider-side supporting portions 62) of the rail portions 57. The front ends of the biasing members 13 are supported on rear surface upper parts (hereinafter, referred to housing-side supporting portions 63) of the base wall portion 18. When the slider 12 is at the standby position, the biasing members 13 are arranged to extend in a natural state between the slider-side supporting portions 62 and the housing-side supporting portions 63. When the slider 12 is at the push-in position, the biasing members 13 are arranged in a state contracted in the front-rear direction between the slider-side supporting portions 62 and the housing-side supporting portions 63.

<Connection Procedure of First and Second Housings>

The slider 12 is assembled with the first housing 10 from behind. As shown in FIG. 9, the retaining portions 51 are locked to the retaining receiving portions 24 while being inserted in the groove portions 23, whereby the slider 12 is arranged at the standby position while being restricted from coming out rearward from the first housing 10. The biasing members 13 are held between the slider-side supporting portions 62 and the housing-side supporting portions 63.

The first housing 10 and the slider 12 are inserted into the receptacle 35 of the second housing 11. By pushing the slider 12 forward (toward the push-in position, toward the second housing 11) while holding the frame portion 49, the connecting operation of the first and second housings 10, 11 can be performed.

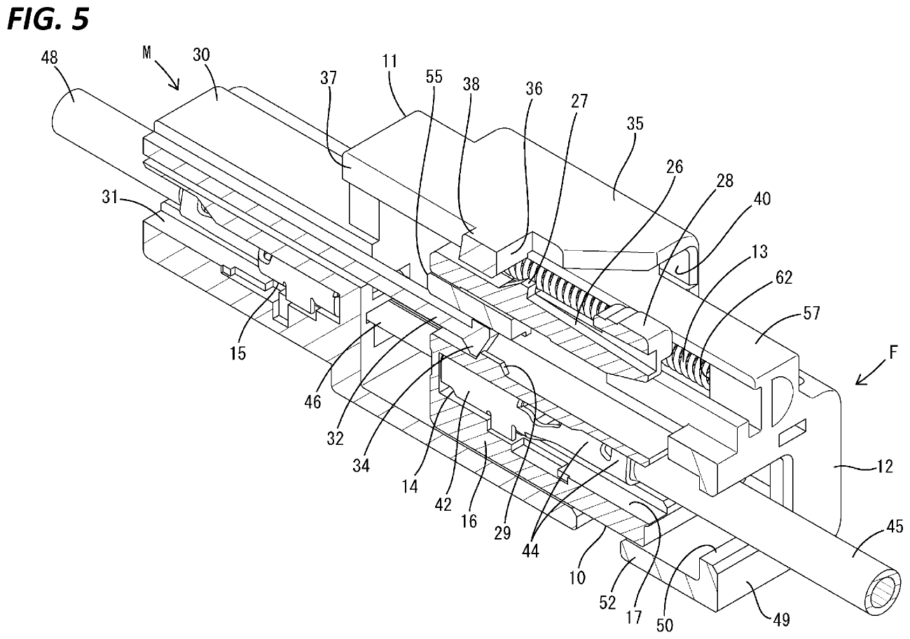

With the slider 12 shallowly inserted in the receptacle 35, the lock body portions 61 of the slider lock portions 59 are inserted into rear parts of the extension grooves 40 of the receptacle 35. Further, with the first housing 10 shallowly inserted in the receptacle 35, the stopper portion 32 is inserted into the through hole 19 and, as shown in FIGS. 5 and 6, the contacted portion 34 of the stopper portion 32 butts against the contact portion 29. By the butting of the stopper portion 32 against the contact portion 29, an inserting operation of the first housing 10 into the receptacle 35 is stopped. That is, the connecting operation of the first and second housings 10, 11 is temporarily stopped. With the connecting operation of the first and second housings 10, 11 stopped, the restricting body 55 of the restricting portion 54 is arranged to be able to contact the restricted portion 33 of the stopper portion 32. In this way, an upward resilient displacement of the stopper portion 32 is suppressed. Further, with the connecting operation of the first and second housings 10, 11 stopped, approaching movements of the first and second terminal fittings 14, 15 are also stopped. At this time, the tabs 46 of the second terminal fittings 15 are arranged in front of the connecting body portions 42 of the first terminal fittings 14. Thus, the first and second terminal fittings 14, 15 are arranged in a state not to contact each other (in a non-contact state).

Also while the connecting operation of the first and second housings 10, 11 is stopped, the push-in of the slider 12 is continued. Since the resilient displacement of the stopper portion 32 is suppressed by the restricting portion 54 during this time, contact between the stopper portion 32 and the contact portion 29 is maintained. By pushing the slider 12, the slider-side supporting portions 62 approach the housing-side supporting portions 63 and the biasing members 13 arranged between the slider-side supporting portions 62 and the housing-side supporting portions 63 are contracted.

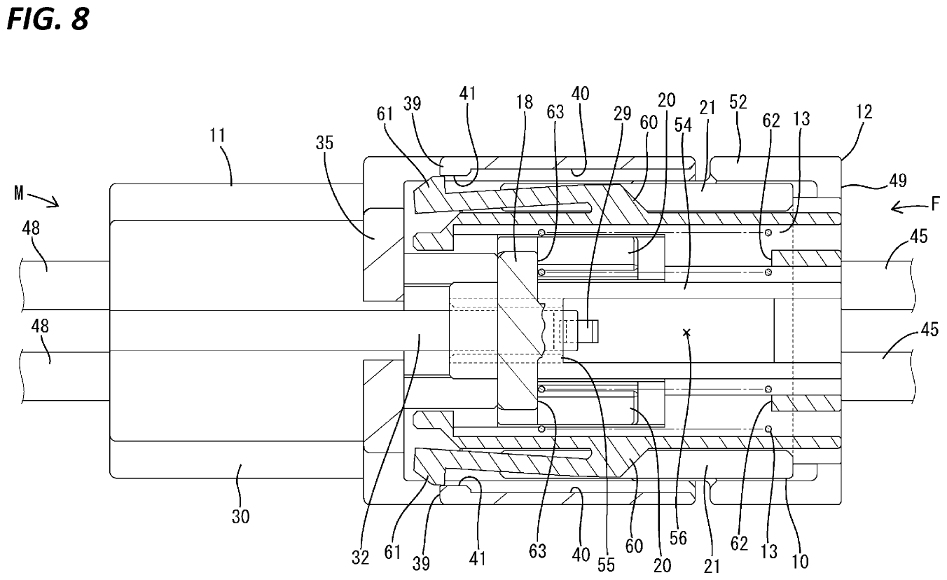

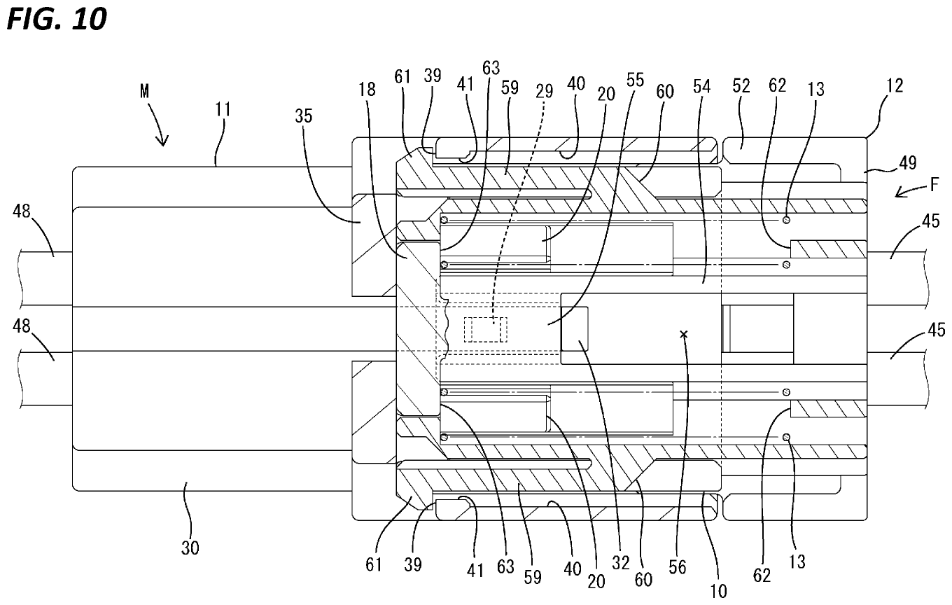

Before the slider 12 reaches the push-in position, the lock body portions 61 come into contact with the closing portions 41 and the slider lock portions 59 are resiliently deformed inwardly (toward the rail portions 57) with the base end portions 60 as fulcrums as shown in FIGS. 7 and 8. Thereafter, the lock body portions 61 pass through the closing portions 41 and the slider lock portions 59 resiliently return, whereby the lock body portions 61 are fit into the slider lock receiving portions 39 as shown in FIG. 10. By locking the slider lock portions 59 to the slider lock receiving portions 39, the slider 12 is restricted from moving relatively backward with respect to the second housing 11. Further, the front ends of the rail portions 57 butt against the rear wall of the receptacle 35, whereby the slider 12 is also restricted from moving relatively forward with respect to the second housing 11. In this way, the slider 12 reaches the push-in position and held (fixed) in the second housing 11 at the push-in position.

When the slider 12 reaches the push-in position, the restricted portion 33 of the stopper portion 32 passes through the restricting body 55 of the restricting portion 54. Further, the contacted portion 34 rides on the contact portion 29 and the stopper portion 32 is resiliently deformed, whereby the restricted portion 33 enters the escaping portion 56. Thereafter, the contacted portion 34 passes through the contact portion 29 and the stopper portion 32 resiliently returns, whereby the restricted portion 33 is retracted from the escaping portion 56. In this way, the contact between the stopper portion 32 and the contact portion 29 is released.

Further, while the slider 12 is moving from the standby position to the push-in position, the biasing members 13 are gradually contracted to accumulate biasing forces. If the push-in of the slider 12 is stopped such as by a worker leaving a hand from the slider 12 before the slider 12 reaches the push-in position, the slider 12 is pushed back by receiving the biasing forces of the biasing members 13. That is, the biasing members 13 elongate rearward with the housing-side supporting portions 63 as support points and forces in a direction separating from the second housing 11 are applied to the slider 12. At this time, the connecting operation of the first and second housings 10, 11 is stopped and a connecting operation of the first and second terminal fittings 14, 15 is not started. Thus, according to this embodiment, a situation where the first and second housings 10, 11 are left in an incompletely connected state can be prevented.

When the slider 12 reaches the push-in position, the slider lock portions 59 are locked to the slider lock receiving portions 39 and the contact between the stopper portion 32 and the contact portion 29 is released, the first housing 10 is moved forward by the biasing forces of the biasing members 13. That is, the biasing members 13 elongate forward with the slider-side supporting portions 62 as support points. As the biasing members 13 elongate forward, the first housing 10 relatively moves toward the connection position to the second housing 11 by receiving the biasing forces of the biasing members 13.

Specifically, if the biasing members 13 elongate forward with the slider-side supporting portions 62 as support points, the housing-side supporting portions 63 are pressed by the biasing members 13 and the first housing 10 automatically moves toward the back side of the receptacle 35. After the slider 12 reaches the push-in position in this way, the connecting operation of the first and second housings 10, 11 proceeds at once by the biasing forces of the biasing members 13.

When the first and second housings 10, 11 reach the connection position, the lock projection 27 is fit into the lock groove 37 as shown in FIG. 9. In this way, the first lock portion 26 is locked to the second lock portion 38 and the first and second housings 10, 11 are held with separation restricted. Further, when the first and second housings 10, 11 reach the connection position, the tabs 46 of the second terminal fittings 15 are inserted into the connecting body portions 42 of the first terminal fittings 14 and contact the contact point parts of the resilient contact pieces 43 and the first and second terminal fittings 14, 15 are conductively connected. The biasing members 13 elongate to return to the initial natural state, and the slider 12 returns to the standby position again with respect to the first housing 10. As shown in FIG. 11, a part of the releasing portion 28 is arranged in the recess 36 of the receptacle 35. In separating the first and second housings 10, 11, the upper surface of the releasing portion 28 is pressed and the first lock portion 26 is resiliently deformed in a direction to be unlocked from the second lock portion 38.

As described above, according to this embodiment, the stopper portion 32 comes into contact with the contact portion 29 and the connecting operation of the first and second housings 10, 11 is stopped while the slider 12 is being pushed from the standby position to the push-in position, whereby it is possible to set a state where the connecting operation of the first and second terminal fittings 14, 15 is not started. As a result, the occurrence of unnecessary contact wear between the first and second terminal fittings 14, 15 can be prevented and connection reliability can be enhanced.

In a state where the slider lock receiving portions 39 are locked by the slider lock portions 59 and the contact between the stopper portion 32 and the contact portion 29 is released after the slider 12 reaches the push-in position, the first housing 10 can be pushed by the biasing forces of the biasing members 13 and quickly reach the connection position to the second housing 11.

On the other hand, if the push-in of the slider 12 is stopped before the slider lock receiving portions 39 are locked by the slider lock portions 59, the slider 12 is pushed back in the direction separating from the second housing 11 by the biasing forces of the biasing members 13. As a result, it is possible to prevent a situation where the first and second housings 10, 11 are left in the incompletely connected state before reaching the connection position.

Further, since the slider 12 includes the restricting portion 54 for keeping the contact between the stopper portion 32 and the contact portion 29 by pressing the stopper portion 32, the contact between the stopper portion 32 and the contact portion 29 can be reliably maintained while the slider 12 is being pushed from the standby position to the push-in position. On the other hand, by the separation of the restricting portion 54 from the stopper portion 32 after the slider 12 reaches the push-in position, the pressing of the stopper portion 32 can be automatically released. Further, since the slider 12 includes the frame-like frame portion 49 behind the rear surface of the housing body 16 of the first housing 10, a wide push-in region (gripping region) can be secured.

### Other Embodiments of Present Disclosure

The embodiment disclosed this time should be considered illustrative in all aspects, rather than restrictive.

In the case of the above embodiment, the first terminal fitting is a female terminal fitting, into which the tab is insertable, and the second terminal fitting is a male terminal including the tab. However, contrary to the above embodiment, the first terminal fitting may be a male terminal fitting including a tab and the second terminal fitting may be a female terminal fitting, into which the tab is insertable, as another embodiment. If the first terminal fitting is a male terminal fitting, the first housing may be shaped to include a receptacle.

In the case of the above embodiment, the first lock portion is resiliently deformably provided and the second lock portion is projection-like and fixedly provided. However, contrary to the above embodiment, the first lock portion may be projection-like and fixedly provided and the second lock portion may be resiliently deformably provided as another embodiment.

Although the biasing member is constituted by a coil spring in the case of the above embodiment, the biasing member may be constituted by any one of a leaf spring, a torsion spring, a resin spring and rubber as another embodiment.

Although the escaping portion is shaped as a hole penetrating through the restricting portion in the case of the above embodiment, the escaping portion may be a bottomed recess open in the lower surface (surface facing the contact portion) of the restricting portion and closed on the upper surface of the restricting portion.

### LIST OF REFERENCE NUMERALS

F . . . first connector

M . . . second connector

10 . . . first housing

11 . . . second housing

12 . . . slider

13 . . . biasing member

14 . . . first terminal fitting

15 . . . second terminal fitting

16 . . . housing body

17 . . . first cavity

18 . . . base wall portion

19 . . . through hole

20 . . . inner wall portion

21 . . . outer wall portion

22 . . . guide space

23 . . . groove portion

24 . . . retaining receiving portion

25 . . . guide groove

26 . . . first lock portion

27 . . . lock projection

28 . . . releasing portion

29 . . . contact portion

30 . . . terminal accommodating portion

31 . . . second cavity

32 . . . stopper portion

33 . . . restricted body

34 . . . contacted portion

35 . . . receptacle

36 . . . recess

37 . . . lock groove

38 . . . second lock portion

39 . . . slider lock receiving portion

40 . . . extension groove

41 . . . closing portion

42 . . . connecting body portion

43 . . . resilient contact piece

44 . . . first barrel portion

45 . . . first wire

46 . . . tab

47 . . . second barrel portion

48 . . . second wire

49 . . . frame portion

50 . . . opening

51 . . . retaining portion

52 . . . peripheral wall portion

53 . . . guide portion

54 . . . restricting portion

55 . . . restricting body

56 . . . escaping portion

57 . . . rail portion

58 . . . accommodation space

59 . . . slider lock portion

60 . . . base end portion

61 . . . lock body portion

62 . . . slider-side supporting portion

63 . . . housing-side supporting portion

1. A connector, comprising:
a first housing;
a second housing connectable to the first housing;
a slider to be supported on the first housing, the slider being relatively movable with respect to the first and second housings; and
a biasing member to be resiliently deformably arranged between the slider and the first housing,
the first housing including a contact portion,
the slider including a slider lock portion,
the second housing including a stopper portion for stopping a connecting operation of the first and second housings by coming into contact with the contact portion while the slider is being pushed toward the second housing and a slider lock receiving portion for stopping push-in of the slider by being locked by the slider lock portion,
the biasing member having a biasing force for pushing the first housing toward a connection position to the second housing when the slider lock receiving portion is locked by the slider lock portion and contact between the stopper portion and the contact portion is released,
the first housing including a first lock portion arranged away from the contact portion, and
the second housing including a second lock portion arranged away from the stopper portion, the second lock portion being locked to the first lock portion at the connection position.

2. A connector, comprising:
a first housing;
a second housing connectable to the first housing;
a slider to be supported on the first housing, the slider being relatively movable with respect to the first and second housings; and
a biasing member to be resiliently deformably arranged between the slider and the first housing,
the first housing including a contact portion,
the slider including a slider lock portion,
the second housing including a stopper portion for stopping a connecting operation of the first and second housings by coming into contact with the contact portion while the slider is being pushed toward the second housing and a slider lock receiving portion for stopping push-in of the slider by being locked by the slider lock portion,
the biasing member having a biasing force for pushing the first housing toward a connection position to the second housing when the slider lock receiving portion is locked by the slider lock portion and contact between the stopper portion and the contact portion is released,
the stopper portion being resiliently deformable, and
the slider including a restricting portion for keeping the contact between the stopper portion and the contact portion by suppressing a resilient displacement of the stopper portion.

3. The connector of claim 1, wherein the slider includes a frame-like frame portion behind a surface on a rear side of the first housing when a moving side of the first housing toward the connection position to the second housing is a front side and a side opposite to the front side is the rear side.

4. The connector of claim 2, wherein the slider includes a frame-like frame portion behind a surface on a rear side of the first housing when a moving side of the first housing toward the connection position to the second housing is a front side and a side opposite to the front side is the rear side.
